(19) United States
(12) Patent Application Publication
(10) Pub. No.: US 2002/0026334 A1
(43) Pub. Date: Feb. 28, 2002

(54) AGENT-CENTRIC INSURANCE QUOTING SERVICE

(76) Inventor: EDWARD W. IGOE, DANVILLE, CA (US)

Correspondence Address: SKJERVEN MORRILL MACPHERSON LLP, 25 METRO DRIVE, SUITE 700, SAN JOSE, CA, 95110, US

(21) Appl. No.: 09/199,032

(22) Filed: Nov. 23, 1998

(51) Int. Cl. G06F 17/60

(52) U.S. Cl. 705/4

(57) ABSTRACT

A method and apparatus are provided that allow insurance agents to virtually present insurance quotes to potential clients over the Internet and the web. This is accomplished by first collecting information from a user and generating an insurance quote based on the information collected from the user. An agent list is then presented to the user, who, in turn, selects an agent from the agent list. Finally, the insurance quote is presented to the user together with information regarding the selected agent. As a result, the insurance quote is presented to the user as if the selected agent were actually providing the quote directly to the user. This presentation mode allows captive agents to maintain their exclusive quote presentation role with users of the system, while, at the same time, eliminating the time delay introduced by the off-line quoting process.

### CROSS REFERENCE TO MICROFICHE APPENDIX

Microfiche appendix A, which is part of the present disclosure, is an appendix consisting of a single sheet of microfiche containing a total of 21 frames listing segments of a computer program and related data, according to an embodiment of the invention. These listings of computer program contains material which is subject to copyright protection. The copyright owner has no objection to the facsimile reproduction by anyone of the patent document or the present disclosure, as it appears in the Patent and Trademark Office patent files or records, but otherwise reserves all copyright rights whatsoever.

### BACKGROUND OF THE INVENTION

1. Field of the Invention

The present invention relates generally to computers and, more particularly, to computer-implemented systems for providing insurance quote information.

2. Related Art

Computer systems are routinely used to generate insurance quotes based on information provided by the insured. The information that is provided by the insured varies depending on both the subject of the insurance policy to be underwritten and the type of coverage desired. For instance, in the case of automobile insurance, the information provided by the insured includes information about the vehicle or vehicles to be covered under the policy, information about the driver or drivers to be covered under the policy, and information about the type of coverage requested by the insured.

Since insurance quotes are typically based on statistical data which is correlated to the information provided by the insured, computers can greatly reduce the time and expense associated with generating insurance quotes. In particular, computer quoting systems allow insurance agents to provide accurate quotes to potential clients in a matter of minutes by inputting the client's information into the system and automatically generating quotes based on the information provided by the client.

The increasing popularity of the Internet and the World-Wide Web (the web) have led to the development of automated insurance quoting systems that are accessible directly over the web. Operation of one such system is illustrated in FIG. 1. In automated insurance quoting operation 100 of FIG. 1, a computer program is first executed in stage 110, whereby information is collected from a user of a client computer connected to a server computer via the Internet and the web. The information collected in stage 110 varies accordingly to the type of insurance quote requested by the user (e.g., automobile, homeowner, life, health, etc.) and may include information about the user (e.g., name, address, date of birth, etc.), information about the subject of the insurance policy to be underwritten (e.g., automobile information for auto insurance, medical history for health insurance, etc.) and information about the type of coverage requested (e.g., deductible amount, maximum liability, etc.). In stage 120, the computer program then evaluates the information provided by the user and generates a number of insurance quotes by comparing the information provided by the user with insurance rate information provided by insurance carriers.

A quote pad page is then presented to the user in stage 130. The Quote Pad page contains information about both on-line and off-line quotes available to the user. On-line quotes can be presented directly to the user by the computer program, while off-line quotes are sent to the user by alternate means such as e-mail or regular mail at a later time. In stage 150, the user elects whether to receive off-line quotes, in which case operation 100 proceeds to stage 152. Otherwise, if the user elects to receive on-line quotes, operation 100 proceeds to stage 190. In addition, during stage 130, the user can opt to save the information already entered for use at a later time by accessing an account creation page in stage 140. In stage 152, the user enters personal information. Stage 154 then determines whether any agents are able to provide a quote to the user, in which case operation 100 proceeds to stage 160; otherwise operation 100 proceeds to stage 170. In stage 160, an agent selection page is presented to the user. The user then selects an agent from whom to receive an off-line quote. The user information is then sent to the selected agent who, in turn, sends a quote to the user, typically, by mail.

In case the user elects to receive on-line quotes from companies that do not require agents to present quotes, a page displaying the quote details is presented to the user in stage 190. If the user then elects to request coverage, personal contact information is entered by the user in stage 195 and forwarded to the quoting insurance company for further processing of the insurance application. Operation 100 then proceeds to stage 170.

Finally, in stage 170, a thank you page is presented to the user summarizing the quotes presented and providing the user with a further option for storing the information entered by accessing the account creation page in stage 180.

This system, however, presents some limitations for insurance companies that present insurance quotes exclusively through their agents. Such agents, sometimes referred to as captive agents, typically work exclusively for one insurance company. In exchange for the exclusivity, the insurance company agrees to sell insurance policies only through its captive agents. To fit within the captive agent model, the system of FIG. 1 relies on an off-line quoting system in which the user requests a quote by selecting an agent and the agent later contacts the user with the quote. The offline quoting, however, adds additional time to the quoting process. There is thus a need for a system that allows captive agents to provide insurance quotes to users on-line.

### SUMMARY OF THE INVENTION

The method and apparatus of the present invention allow insurance agents to virtually present insurance quotes to potential clients over the Internet. This is accomplished by first collecting information from a user and generating an insurance quote based on the information collected from the user. An agent list is then presented to the user, who, in turn, selects an agent from the agent list. Finally, the insurance quote is presented to the user together with information regarding the selected agent.

As a result, the insurance quote is presented to the user as if the selected agent were actually providing the quote directly to the user. This presentation mode allows captive agents to maintain their exclusive quote presentation role with users of the system, while, at the same time, eliminating the time delay introduced by the off-line quoting process.

### BRIEF DESCRIPTION OF THE DRAWINGS

FIG. 1 is a flow diagram of the operation of a prior art automated insurance quoting system.

FIG. 2A is a flow diagram of the operation of an agent-centric automated insurance quoting system according to an embodiment of the invention.

FIG. 2B is a flow diagram of stage 205 of the operation of FIG. 2A.

FIG. 3 is a diagram of a quote pad page, according to an embodiment of the invention.

FIG. 4 is a diagram of an agent selection page, according to an embodiment of the invention.

FIG. 5A is a diagram of an agent information page, according to an embodiment of the invention.

FIG. 5B is a diagram of an agent information page including geo-coded directions to an agent's office.

FIG. 5C is a diagram of an agent information page, according to an embodiment of the invention.

FIG. 6 is a diagram of a quote details page, according to an embodiment of the invention.

FIG. 7 is a diagram of the quote pad page of FIG. 3, after an agent selection operation.

FIG. 8A is a diagram illustrating a client computer and a server computer connected by a global network.

FIG. 8B is a block diagram of the logical structure of the hardware and software components of the client computer of FIG. 8A.

FIG. 8C is a flow diagram illustrating the execution of a software program on the server computer of FIG. 8A when a “home page” of the automated insurance quoting system of FIG. 2 is accessed.

FIG. 8D is a flow diagram illustrating the execution of a software program on the server computer of FIG. 8A when subsequent pages of the automated insurance quoting system of FIG. 2 are accessed.

### DETAILED DESCRIPTION OF THE INVENTION

The present invention provides a method and apparatus for automatically quoting insurance policy rates based on information supplied by the user, where the insurance quote is presented by a virtual insurance agent.

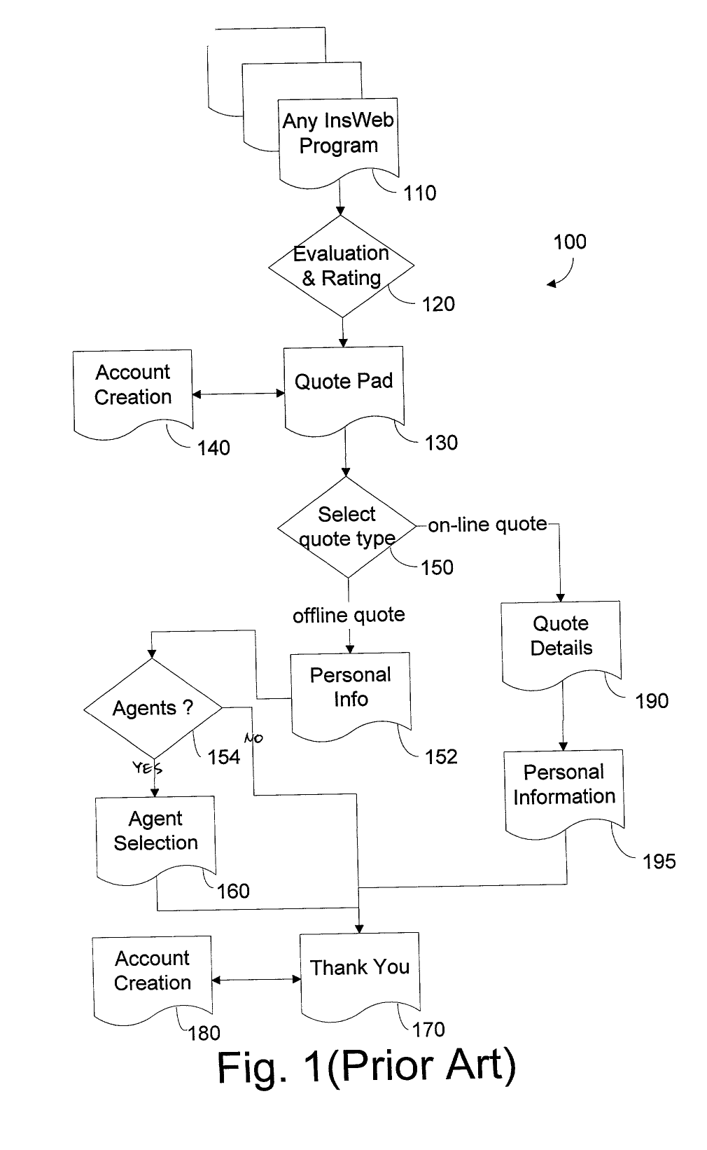

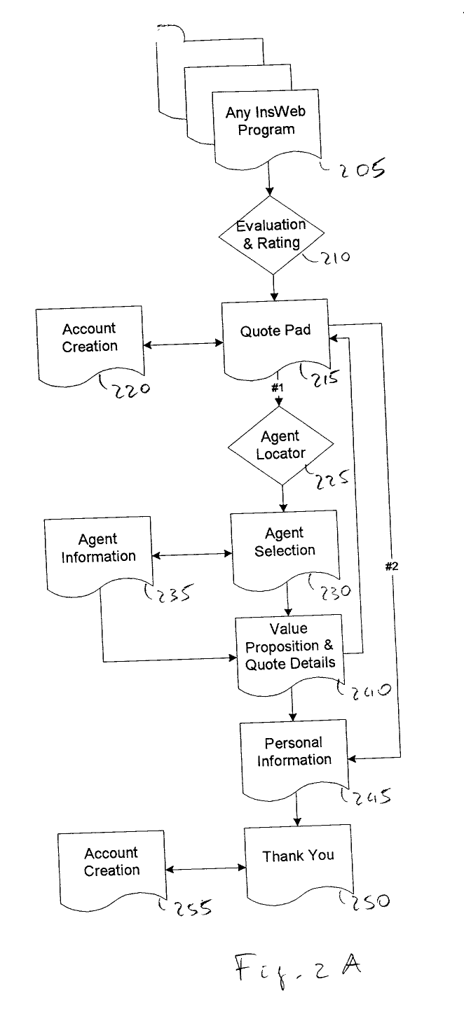

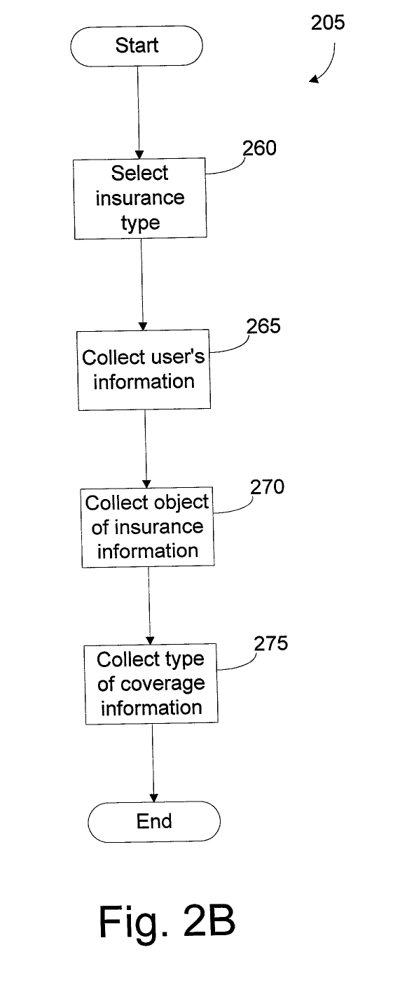

A flow diagram of the operation of an automated insurance quoting system 200 in accordance to an embodiment of the invention is depicted in FIG. 2. In FIG. 2, information about the user, the object of the insurance policy to be underwritten and the type of coverage desired is collected in stage 205, in a manner analogous to the one described with respect to the prior art system of FIG. 1. FIG. 2B illustrates the flow of operation 200 during stage 205 in greater detail. First, in stage 260, the user selects an insurance type for which the quote is requested. In stage 265, the user's information (e.g., address, date of birth, etc.) is optionally collected. Information about the object of the insurance policy to be underwritten is collected in stage 270. Finally, information about the type of coverage requested by the user is collected in stage 275.

Those skilled in the art realize that the particular order of the operations depicted in FIGS. 2A and 2B is purely illustrative. In fact, these operations can be performed in any order that does not violate data dependencies described herein. For example, information about the object of the insurance policy could be collected either before of after the user's information is collected. However, insurance quotes cannot be determined based on the user's information unless such information has been collected in a previous stage.

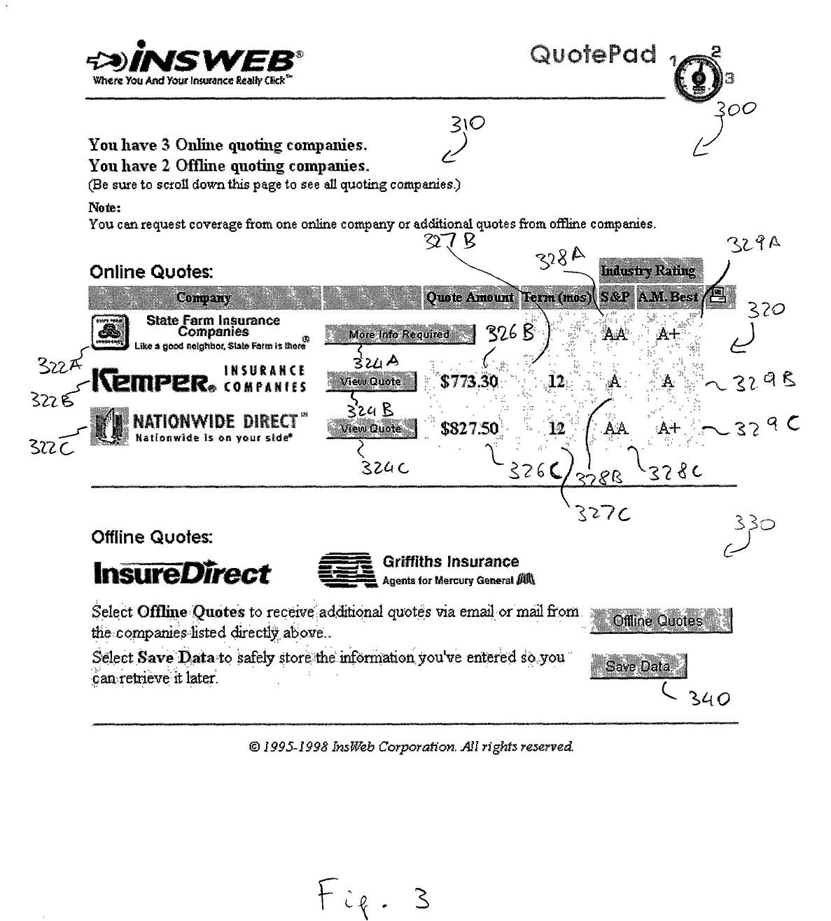

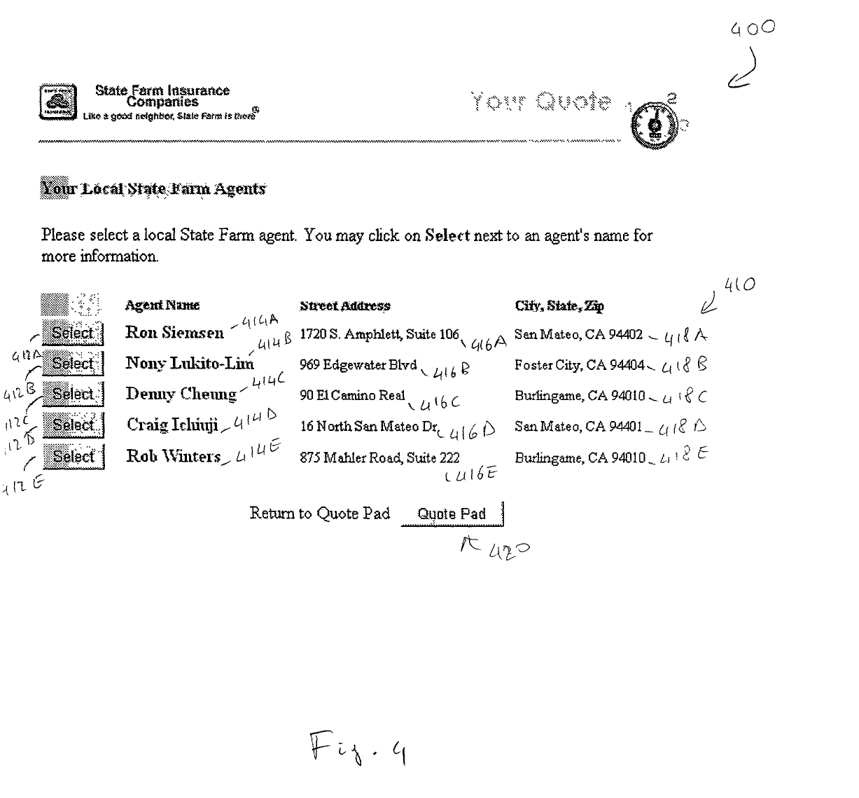

In stage 210, the information entered by the user is evaluated and compared to information supplied by insurance companies to determine whether individual insurance companies provide the coverage requested by the user and, if so, at what rates. A quote pad page 300 (FIG. 3) is then displayed to the user in stage 215. Quote pad page 300 includes a summary section 310, an on-line quote section 320 and an off-line section 330. Summary section 310 displays a summary of the number of on-line and off-line insurance quotes available to the user. On-line section 320, in turn, displays information regarding on-line quotes available to the user. In the embodiment depicted in FIG. 3, the information displayed for each available quote displayed in on-line section 310 are an insurance company icon 322n (where n=A, B, C), an action button 324n, a quote field 326n, a term field 327n, an S&P rating field 328n and an A.M. Best rating field 329n. Insurance company icon 322n indicates the insurance company that is presenting the quote. If the insurance company indicated by insurance company icon 322n allows quotes to be presented directly to the user, the corresponding action button 324n indicates that the quote can be directly displayed by clicking on action button 324n (action buttons 324B and 324C). Alternatively, if the insurance company requires that quotes be presented by an agent, the corresponding action button indicates to the user that additional information is required (action button 324A). If the user clicks action button 324A, in stage 225 one or more agents representing the insurance company are selected based on the geographical information provided by the user and an agent selection page 400 (FIG. 4) is displayed in stage 230. If the user clicks save button 340, the information entered by the user is saved in stage 220, in a manner analogous to the one described with respect to stage 255.

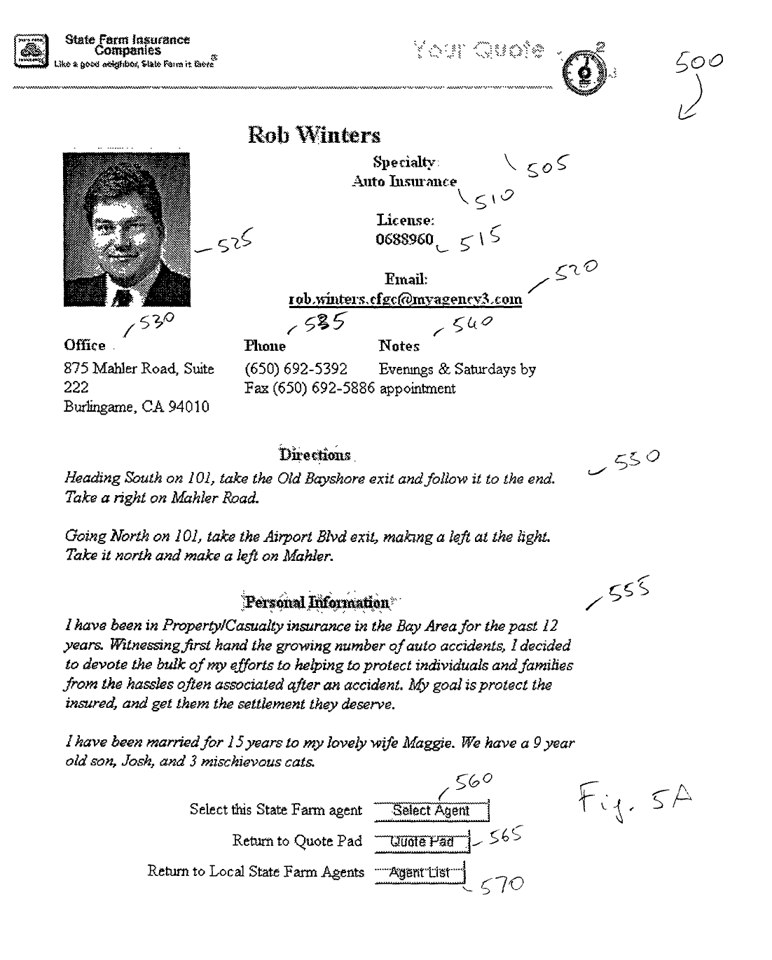

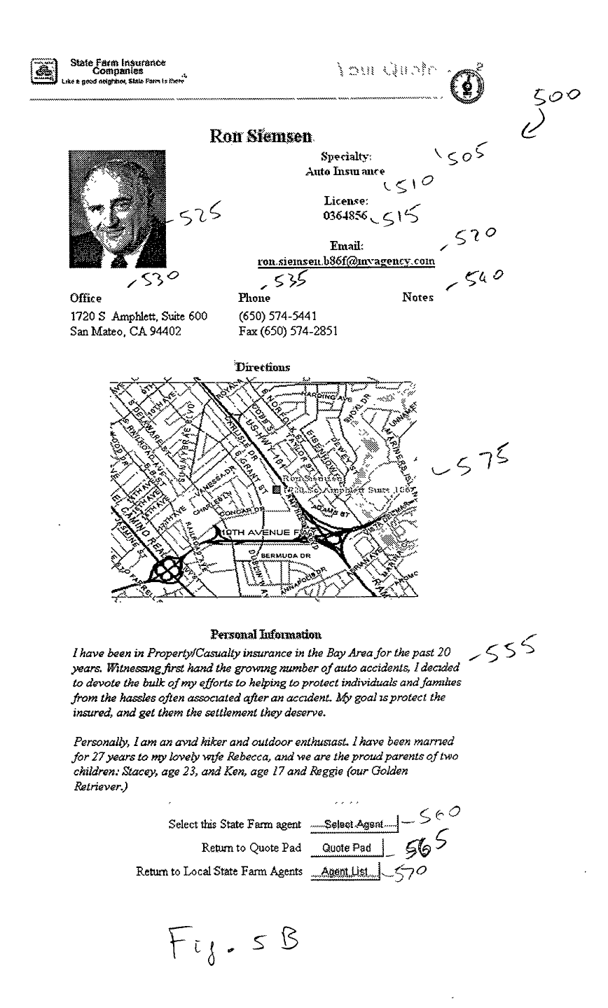

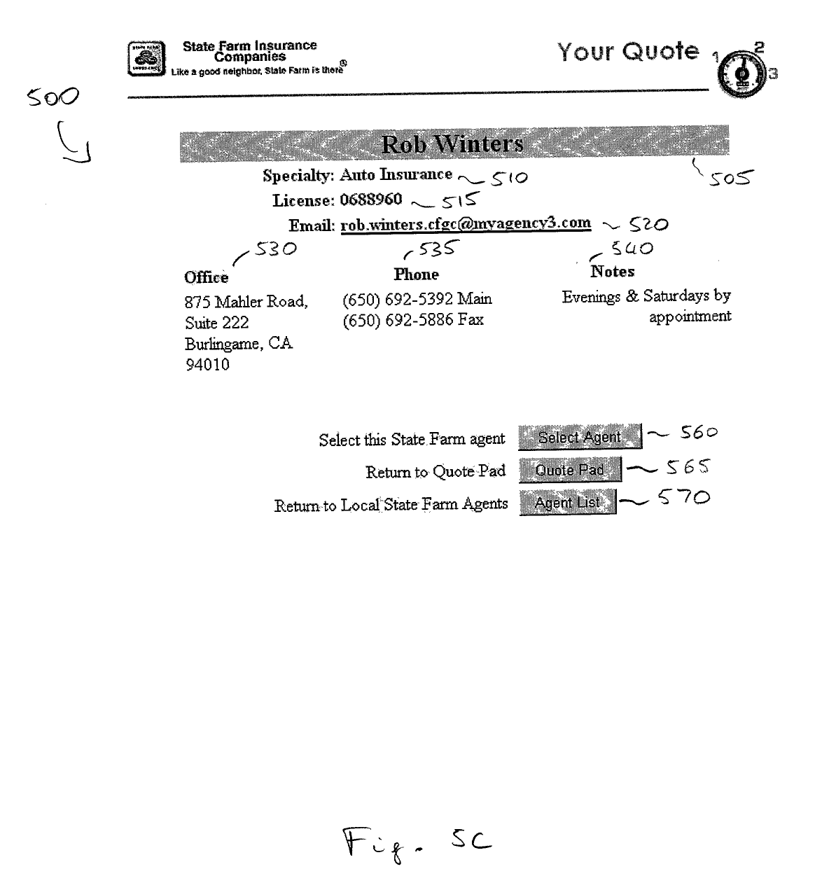

Agent selection page 400 has an agent list 410 and a return-to-quote-pad button 420. In the embodiment of FIG. 4, the information displayed for each insurance agent listed in agent list 410 includes a select button 412n (where n=A, B, C, D, E), an agent name 414n, an agent address 416n, and an agent city 418n. In order to select an insurance agent from agent list 410, the user simply clicks on a corresponding select button 412n in stage 230, the agent information is collected in stage 235 and displayed to the user in an agent information page 500. FIGS. 5A, 5B and 5C illustrate embodiments of agent information page 500.

The agent information page 500 shown in FIG. 5A includes a name field 505, a specialty field 510, a license number field 515, an e-mail address field 520, a picture icon 525, an office address field 530, a phone number field 535, a notes field 540, a directions field 550, a personal information field 555, a select button 560, a quote pad button 565, and an agent list button 570.

The layout of agent information page 500 shown in FIG. 5B is identical to the one shown in FIG. 5A except that a map 575 is shown in place of directions field 550. The layout of agent information page 500 shown in FIG. 5C is identical to the one shown in FIG. 5A except that picture icon 525, directions field 550 and personal information field 555 are not shown.

According to an embodiment of the invention, different levels of listings can be provided to insurance agents participating in automated insurance quoting system 200. For instance, agent information page 500 of FIG. 5C can be offered as a basic subscription service for insurance agents, while agent information page 500 of FIG. 5A or 5B is offered as an upgraded service to insurance agents.

While specific embodiments are shown in FIGS. 5A and 5B, the invention can be applied to any variation of a page listing information regarding an insurance agent and the invention is not limited to the specific types of information shown in FIGS. 5A and 5B. For example, additional information such as membership in professional organizations, certifications (e.g., e-commerce insurance training certification) could be displayed in addition to or in lieu of the information described with respect to FIGS. 5A and 5B.

If the user clicks on select agent button 560, the agent whose information is displayed on agent information page 500 is selected and operation 200 proceeds to stage 240. Alternatively, if the user clicks on quote pad button 565, quote pad page 300 is again displayed to the user and operation 200 reverts to stage 215. Finally, if the user clicks on agent selection button 570, agent selection page 400 is again displayed to the user and operation 200 reverts to stage 230.

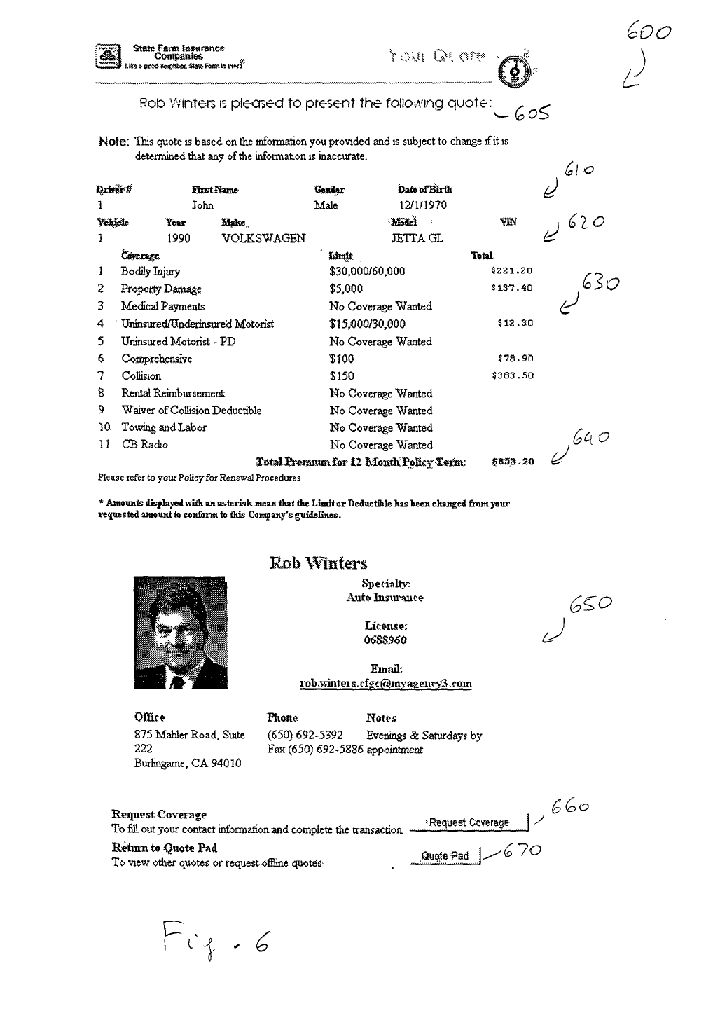

In stage 240, quote details page 600 (FIG. 6) is presented to the user. Quote details page 600 includes an agent introduction field 605, a drivers section 610, a vehicles section 620, a rate section 630, a premium field 640, an agent section 650, a request coverage button 660, and a quote pad button 670. Agent introduction field 605 effectively introduces the agent presenting the quote to the user. Drivers section 610 summarizes the information entered by the user for all drivers considered in generating the insurance quote. Similarly, vehicles section 620 summarizes the information entered by the user for all vehicles considered in generating the insurance quote. Rate section 630 then breaks down the insurance premium based on different types of coverage requested by the user. Premium field 640 indicates to the user the premium amount and the policy term that constitute the quote. Agent section 650 summarizes the agent information displayed in agent information window 500.

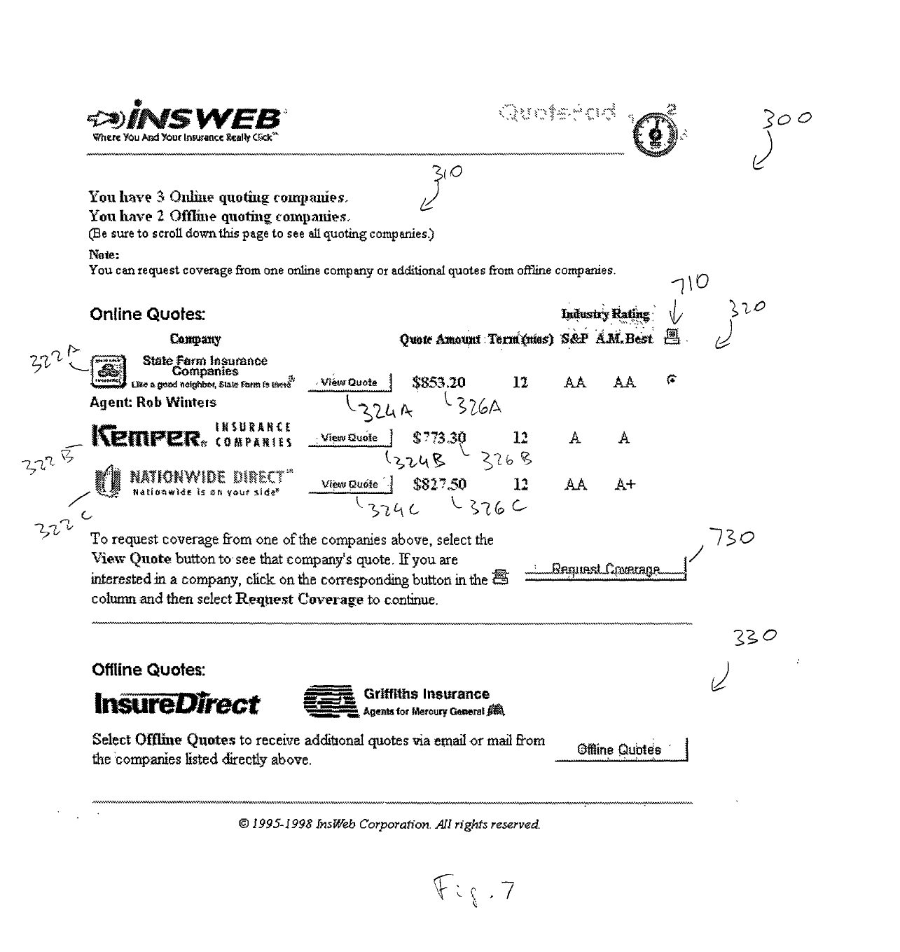

If the user clicks on request coverage button 660, operation 200 proceeds to stage 245. Alternatively, if the user clicks on quote pad button 670, quote pad page 300 (FIG. 7) is again displayed to the user and operation 200 reverts to stage 215. FIG. 7 illustrates quote pad page 300 as it appears in stage 215 of operation 200 after processing of stage 240. The quote pad page 300 of FIG. 7 is identical to the quote pad page 300 shown in FIG. 3, except that the name of the selected agent is displayed as part of insurance company icon 322A, action button 324A has the same appearance as action buttons 324B and 324C and a quote amount is displayed in quote field 326A. In addition, a quote selection column 710 and a request coverage button 730 are added to on-line section 320. The user can thus request coverage based on one of the quotes displayed in on-line section 320 by first clicking on a corresponding radio button in selection column 710 and then clicking on request coverage button 730, in which case operation 200 proceeds to stage 245.

In stage 245, personal contact information is obtained from the user to be forwarded to the agent/insurance company selected by the user and operation 200 proceeds to stage 250. In stage 250 a thank you page (not shown) is displayed to the user. Once the thank you page is displayed, the user has the option of either terminating operation 200 or saving the information entered for processing at a later time. If the user elects to save the information entered, operation 200 proceeds to stage 255. In stage 255, an identification code and a password are selected by the user to identify the information entered during operation 200 and the information is stored in a user account keyed to the identification code provided by the user and operation 200 terminates.

If the user elects to use the automated insurance quoting system at a later time, an option is presented to the user to either enter new information or retrieve information stored in the user account. The information stored in the user account can then be retrieved by the user by supplying the identification code and password provided during operation 200.

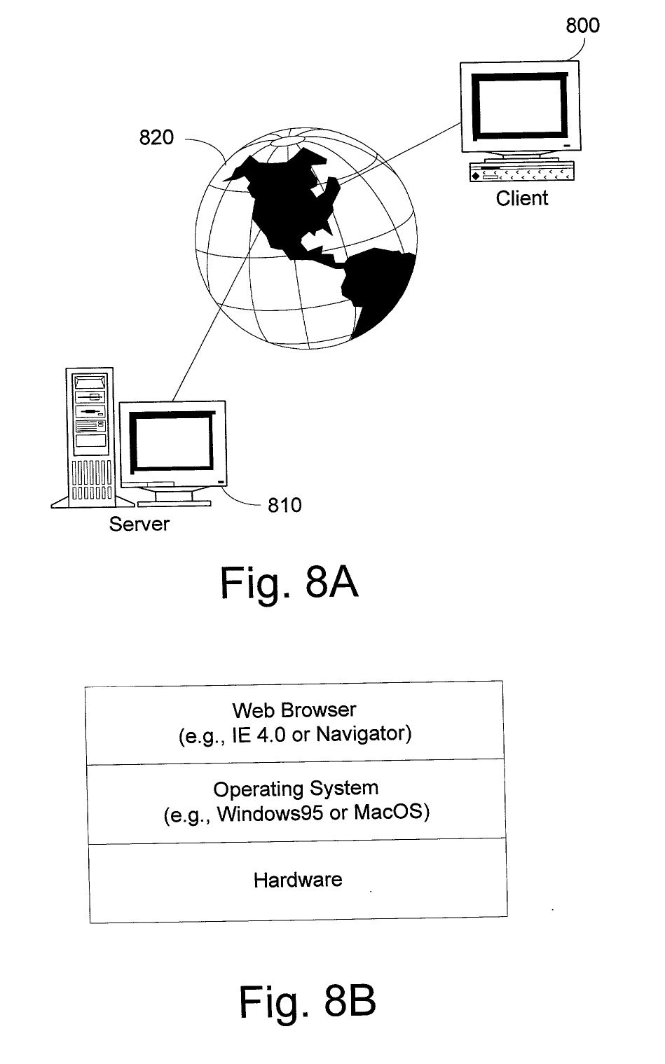

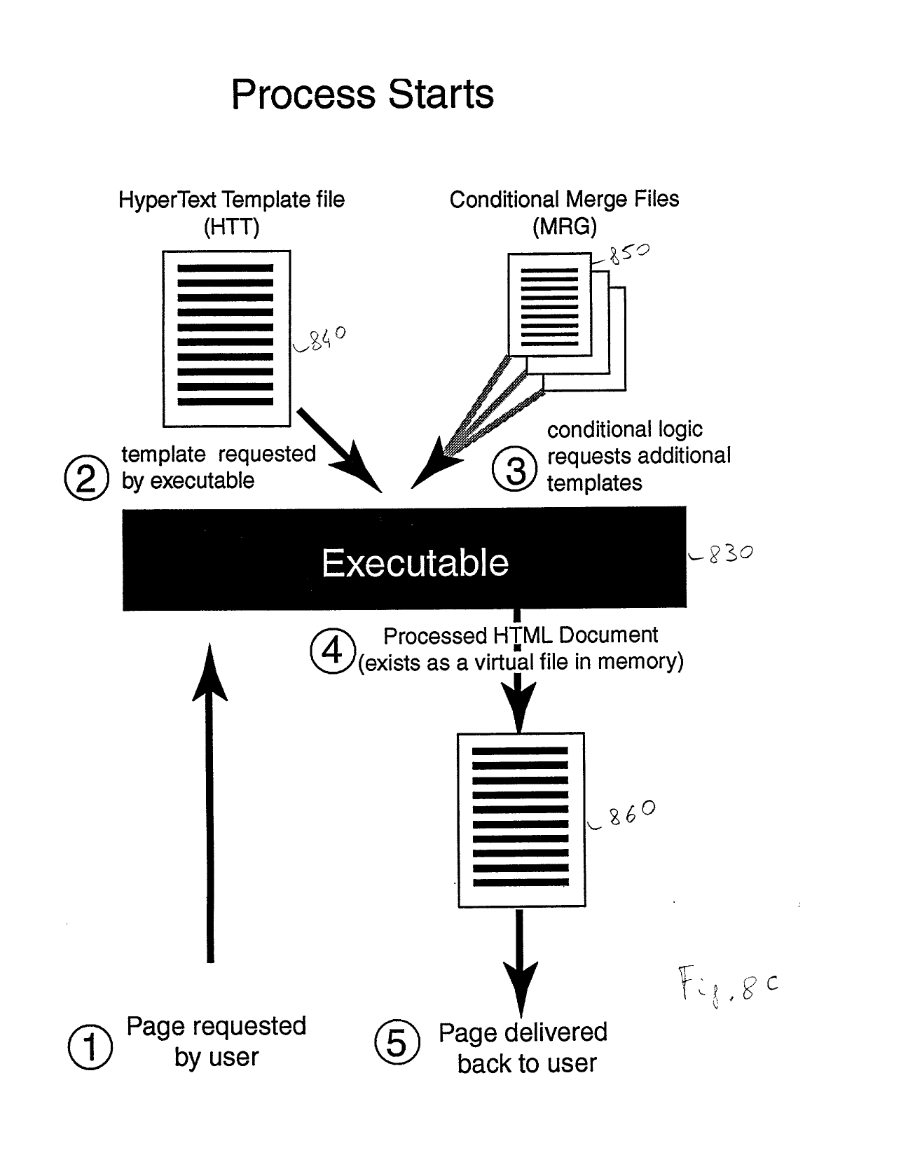

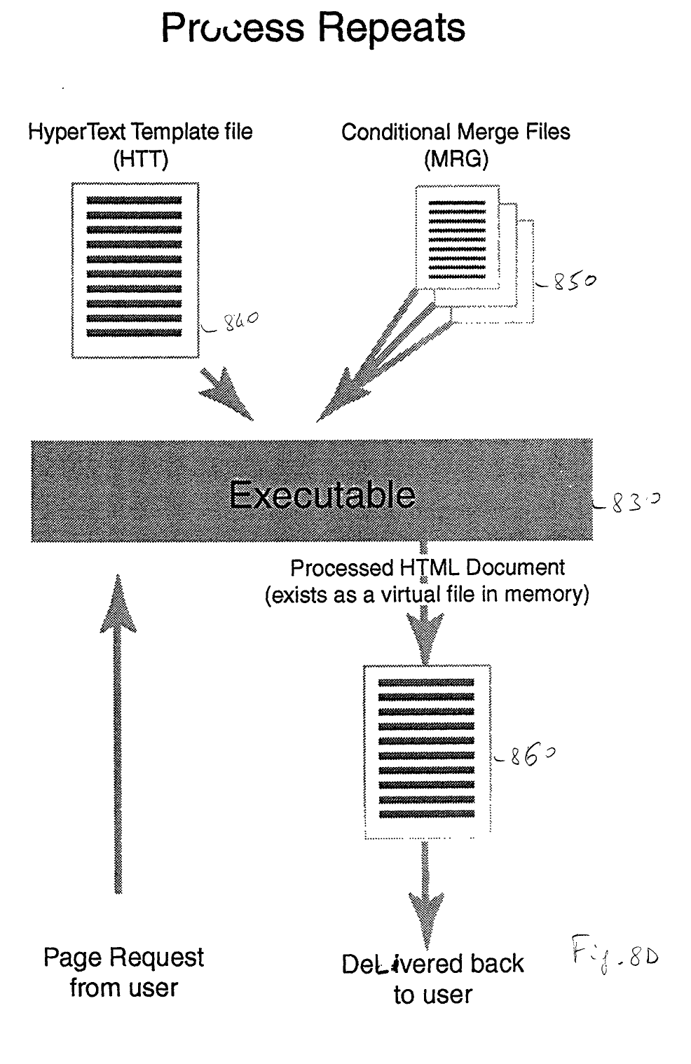

One implementation of a computer system according to an embodiment of the invention is described in FIGS. 8A-8D. FIGS. 8A and 8B illustrate a client computer 800 executing a web browser program such as Internet Explorer or Netscape Navigator connected to a server computer 810 over a global network 820 such as the Internet and the web. FIG. 8B illustrates the logical structure of the hardware and software of client computer 800. In FIG. 8B, a web browser program such as Internet Explorer 4.0, available from Microsoft Corporation of Redmond Wash., or Netscape Navigator® 4.0, available from Netscape Communications Corp. of Mountain View, Calif., is shown executing on top of an operation system such as Windows95®, Windows98®, Windows NT® 4.0, available from Microsoft Corporation of Redmond Wash., or MacOS™ 8.5, available from Apple Computer, Inc. of Cupertino Calif., in turn, executing on top of the actual hardware of client computer 800 (FIG. 8A).

FIGS. 8C and 8D illustrate the operation of the software program executed by server computer 810. As shown in FIG. 8C, a user accesses the automated insurance quoting system by first requesting the “home page” of the automated insurance quoting service via client computer 800 connected to server computer 810. An executable program 830 running on server computer 810 then retrieves an HTT template file 840, also stored on the server computer and one or more conditional merge files 850. Executable program 830, HTT template file 840 and conditional merge files 850 are protected by means of a network firewall installed on server computer 800 to prevent unauthorized access to sensitive information such as insurance rating information. Executable program 830 then merges HTT file 840 and merge files 850 to generate processed HTML document 860 that is displayed on a screen of client computer 800. Conditional merge files 850 store information such as individual insurance companies' value propositions or other information that may vary within an HTT template file 840.

FIG. 8D illustrates how additional pages are accessed by the user in a similar manner to the one shown in FIG. 8C.

MacOS is a trademark of Apple Computer, Inc. of Cupertino, Calif., Windows95, Windows98 and Windows NT are registered trademarks of Microsoft Corporation of Redmond, Wash., Netscape Navigator is a registered trademark of Netscape Communications Corp. of Mountain View, Calif.

Embodiments described above illustrate but do not limit the invention. In particular, the invention is not limited to the appearance of the web pages described herein. Those skilled in the art realize that alternative web pages can be employed in lieu of the ones described herein in accordance to the principles of the present invention. Furthermore, the invention is not limited to any particular insurance type. For example, the invention can be used in insurance industries other than automobile, homeowner, life and health. Similarly, the invention is not limited by any particular categories of information collected from the user. For example, other information may be entered by the user depending on the type of insurance coverage desired. Other embodiments and variations are within the scope of the invention, as defined by the following claims.

I claim:

1. A method for providing insurance quotes over a global computer network, the method comprising:
collecting information from a user;
generating an insurance quote based on the information collected from the user;
presenting an agent list to the user;
the user selecting an agent from the agent list; and
in response to the user selecting the agent from the agent list, presenting the insurance quote to the user together with information regarding the selected agent.

2. The method of claim 1, further comprising:
generating additional insurance quotes based on the information collected from the user;
presenting a list of insurance companies available to the user;
the user selecting one or more of the insurance companies; and
in response to the user selecting the insurance companies, presenting insurance quotes from the selected insurance companies to the user.

3. The method of claim 2, wherein presenting the insurance quotes to the user further comprises presenting at least one of the quotes together with information about an agent presenting the quote.

4. The method of claim 1, wherein collecting information from a user further comprises:
collecting information about the user;
collecting information about a subject of an insurance policy for which the insurance quote is requested; and
collecting information about coverage sought by the user for the subject of the insurance policy.

5. The method of claim 1, wherein presenting the insurance quote to the user together with information regarding the selected agent further comprises:
presenting to the user a name of the agent;
presenting to the user an address of a place of business of the agent; and
presenting to the user a telephone number of the agent.

6. The method of claim 5, wherein presenting the insurance quote to the user together with information regarding the selected agent further comprises:
presenting to the user biographical data regarding the agent; and
presenting to the user a picture of the agent.

7. The method of claim 1, wherein the global computer network is the Internet.

8. The method of claim 1, wherein the insurance quote and the information regarding the selected agent are presented as part of a single web page.

9. The method of claim 1, further comprising:
retrieving a template file stored on a server computer connected to the global network;
retrieving a conditional merge file stored on a server computer connected to the global network;
merging the template file with the conditional merge file to generate a merged document; and
displaying the merged document to the user on a client computer connected to the global network.

10. The method of claim 1, further comprising:
the user selecting an insurance type for which the insurance quote is requested.

11. A computer system for providing insurance quotes over a global computer network, the system comprising a server computer and one or more client computers connected to the global computer network, wherein the server computer further comprises computer instructions for:
collecting information from a user;
generating an insurance quote based on the information collected from the user;
presenting an agent list to the user;
detecting that the user has selected an agent from the agent list; and
in response to the user selecting the agent from the agent list, presenting the insurance quote to the user together with information regarding the selected agent.

12. The system of claim 11, wherein the server computer further comprises computer instructions for:
generating additional insurance quotes based on the information collected from the user;
presenting a list of insurance companies available to the user;
detecting that the user has selected one or more of the insurance companies; and
in response to the user selecting the insurance companies, presenting insurance quotes from the selected insurance companies to the user.

13. The system of claim 12, wherein the computer instructions for presenting the insurance quotes to the user further comprise computer instructions for presenting at least one of the quotes together with information about an agent presenting the quote.

14. The system of claim 11, wherein the computer instructions for collecting information from a user further comprise computer instructions for:
collecting information about the user;
collecting information about a subject of an insurance policy for which the insurance quote is requested; and
collecting information about coverage sought by the user for the subject of the insurance policy.

15. The system of claim 11, wherein the computer instructions for presenting the insurance quote to the user together with information regarding the selected agent further comprise computer instructions for:
presenting to the user a name of the agent;
presenting to the user an address of a place of business of the agent; and
presenting to the user a telephone number of the agent.

16. The system of claim 15, wherein the computer instructions for presenting the insurance quote to the user together with information regarding the selected agent further comprise computer instructions for:
presenting to the user biographical data regarding the agent; and
presenting to the user a picture of the agent.

17. The system of claim 11, wherein the global computer network is the Internet.

18. The system of claim 11, wherein the insurance quote and the information regarding the selected agent are presented as part of a single web page.

19. The system of claim 11, wherein the server computer further comprises computer instructions for:
retrieving a template file stored on the server computer;
retrieving a conditional merge file stored on the server computer;
merging the template file with the conditional merge file to generate a merged document; and
displaying the merged document to the user on the client computer.

20. The system of claim 11, wherein the server computer further comprises computer instructions for:
detecting that the user has selected an insurance type for which the insurance quote is requested.

21. A computer data signal embodied in a carrier wave transmitted between a server computer and one or more client computers connected to a global computer network, wherein the computer data signal comprises:
an insurance quote based on information collected from a user of the client computer; and
information regarding an insurance agent selected by the user.

22. The computer data signal of claim 21, further comprising:
a name of the agent;
an address of a place of business of the agent; and
a telephone number of the agent.

23. The computer data signal of claim 21, further comprising:
biographical data regarding the agent; and
a picture of the agent.

24. The computer data signal of claim 21, wherein the global computer network is the Internet.
